(19) United States
(12) Patent Application Publication
(10) Pub. No.: US 2007/0205251 A1
(43) Pub. Date: Sep. 6, 2007

(54) Soldering structure of through hole

(75) Inventors: Norihito Suzuki, Aichi (JP); Akihiro Minoura, Aichi (JP)

Correspondence Address: MORGAN LEWIS & BOCKIUS LLP, 1111 PENNSYLVANIA AVENUE NW, WASHINGTON, DC, 20004, US

(73) Assignee: Kabushiki Kaisha Tokai Rika Denki Seisakusho

(21) Appl. No.: 11/712,955

(22) Filed: Mar. 2, 2007

(30) Foreign Application Priority Data
Mar. 3, 2006 (JP) P.2006-057861

(51) Int. Cl. A47J 36/02

(52) U.S. Cl. 228/101

(57) ABSTRACT

A through hole is formed in a printed board. Conductor patterns are formed on an upper face and a lower face of the printed board in such a manner that the conductor patterns are electrically connected to each other, by means of a through hole solder. A lead terminal of an electronic component is inserted into the through hole and soldered with a lead free solder. According to this invention, an area of an opening of the through hole is set to be four times or more as large as a cross sectional area of the lead terminal. In this manner, heat conduction on occasion of soldering can be enhanced, and the soldering can be favorably performed, even when the lead free solder having a high melting point is used.

### BACKGROUND OF THE INVENTION

The present invention relates to a soldering structure of a through hole in which a lead terminal of an electronic component is soldered to a through hole formed in a printed board, using a lead (Pb) free solder.

In case where an electronic component provided with a lead terminal is mounted on a printed board by forming a through hole therein, the printed board in a state having the lead terminal inserted into the through hole will be dipped in a bath of molten solder, thereby to fill the solder in the through hole. Generally, in this case, when a eutectic solder (Sn—Pb solder) is used, an opening area of the through hole is set to be about twice as large as a cross sectional area of the lead terminal. No document will be particularly referred to, because mounting of a component on a printed board in this manner belongs to general technique.

However, there is a tendency that the eutectic solder as described above is not used in respect of environmental pollution, and a lead free solder has come to be used instead of the eutectic solder. Because the lead free solder has a higher melting point as compared with the eutectic solder, a so-called insufficient solder rise may occur. Specifically, when the printed board is taken out from the bath of molten solder, the solder has not sufficiently risen above an upper face of the through hole. Consequently, there has been a trouble that defective soldering may occur.

The trouble is such as shown in FIG. 4, for example. In FIG. 4, a multi layer printed board 1 is provided with a through hole 2. Conductor patterns 3a, 3b are formed on opposed parts at both sides of the through hole 2, in a state where they are electrically connected to each other by soldering. FIG. 4 shows the multilayer printed board 1 in a state where a lead terminal 4 of an electronic component has been inserted into the through hole 2 and soldered.

In this case, the solder used for soldering is a lead free solder 5. Because the lead free solder 5, has a higher melting point as compared with the eutectic solder of Sn—Pb, as described above, the solder rise will be insufficient when heat conduction is poor. Consequently, in usual dipping process in the bath of molten solder, perfect soldering cannot be achieved, since the lead free solder 5 will be fixed before it arrives at the conductor pattern 3a at the upper face side from the conductor pattern 3b at the lower face side of the multilayer printed board 1, as shown in the drawing.

However, in case where the multilayer printed board 1 has been dipped in the bath of solder for a long time for the purpose of enhancing the heat conduction thereby to improve the solder rise, thermal damage would be given to the electronic component and the printed board to be soldered, to the contrary. Therefore, this is not a favorable solution, practically. For this reason, soldering had better be conducted for an allowable maximal dipping time, which however, will also cause an insufficient solder rise, and there has been probability that soldering performance may be deteriorated.

### SUMMARY OF THE INVENTION

The invention has been made in view of the above described circumstance, and it is an object of the invention to provide a soldering structure of a through hole in which soldering performance can be improved, even in case where an electronic component having a lead terminal is soldered to a through hole formed in a printed board by means of a lead free solder.

According to the invention, a soldering structure includes: a printed board; a through hole formed in the printed board; and an electronic component having a lead terminal soldered to the through hole by lead free solder, wherein an opening area of the through hole is four times or more as large as a cross sectional area of the lead terminal.

In the above described structure, it would be preferable that the lead free solder is a lead free solder of Sn—Ag or Sn—Ag—Cu having a high melting point.

According to the invention, in case where soldering is conducted using the lead free solder, the through hole is formed so that a ratio of the opening area of the through hole with respect to the cross sectional area of the lead terminal may be 4 or more. Therefore, heat conduction in the through hole can be enhanced, and when the printed board has been dipped in the lead free solder, the lead free solder can rise sufficiently up to the upper face of the printed board through the through hole. In this manner, it is possible to achieve improvement of the soldering performance.

By setting the ratio of the opening area of the through hole with respect to the cross sectional area of the lead terminal to be 4 or more, as described above, cracks are likely to occur in case where the conventional eutectic solder is used. In this case, it has been difficult to apply the invention. In this respect, in case where the lead free solder is used, cracks will rarely occur because of properties of the solder.

### BRIEF DESCRIPTION OF THE DRAWINGS

FIGS. 1A and 1B are a schematic view and a schematic plan view showing an embodiment of the invention.

FIG. 2 is a view showing setting conditions of an experiment which has been conducted for the purpose of obtaining data.

FIGS. 3A and 3B are charts showing results of the experiment, and FIG. 3C is a graph showing evaluations of a solder rise with respect to an area ratio.

FIGS. 4A and 4B are views corresponding to FIGS. 1A and 1B for describing the related art.

### DETAILED DESCRIPTION OF PREFERRED EMBODIMENTS

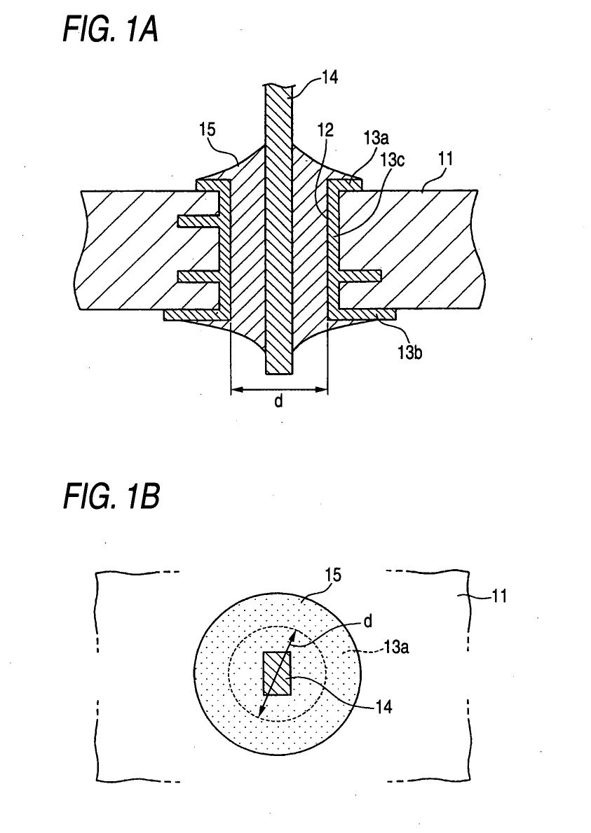

Now, an embodiment of the invention will be described referring to FIGS. 1 to 3.

FIGS. 1A and 1B are a sectional view and a plan view showing the embodiment. A multilayer printed board 11 includes a plurality of wiring layers stacked on one another. Conductor patterns for wiring are formed on both an upper face and a lower face of the multilayer printed board 11, and other conductor patterns for wiring are also formed in inner intermediate layers thereof. A through hole 12 for mounting an electronic component is formed in an illustrated part. Conductor patterns 13a and 13b are formed on the upper face and the lower face of the multilayer printed board 11 in such a manner that the upper and lower conductor patterns 13a, 13b are electrically connected to each other, by means of a through hole soldering part 13c.

The through hole 12 is formed for the purpose of inserting the electronic component therein. A lead terminal 14 of the electronic component is inserted into the through hole 12 and fixed with a lead free solder 15. In the illustrated state, the lead free solder 15 has arrived at a surface of the conductor pattern 13a formed on the upper face of the multilayer printed board 11, whereby a sufficient solder rise has been achieved and favorable soldering performance has been obtained.

In the above described structure, an area S1 of an opening of the through hole 12 can be obtained from a diameter d of the opening, and a cross sectional area S2 of the lead terminal 14 can be obtained from longitudinal and lateral lengths of a cross sectional face thereof. In this illustrated structure, the opening area S1 of the through hole 12 is determined by such an area ratio R that the area S1 may be four times or more as large as the cross sectional area S2 of the lead terminal 14.

By employing such structure, it is possible to sufficiently enhance heat conduction in the through hole 12, by solder dipping when the lead terminal 14 is soldered to the multilayer printed board 11. In this manner, a favorable solder rise in the through hole 12 can be obtained.

It has been confirmed by an experiment that it would be advantageous to set the area ratio R between the opening area S1 of the through hole 12 and the cross sectional area S2 of the lead terminal 14 to be about 4 or more. The results of the experiment will be described below.

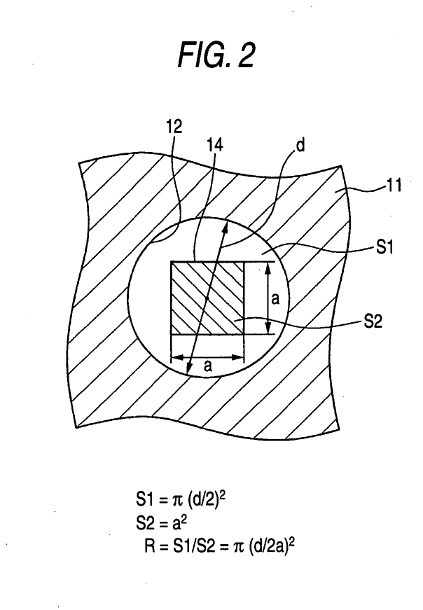

FIG. 2 is a schematic view showing conditions of the experiment, in which the diameter of the through hole 12 formed in the multilayer printed board 11 is d, and the cross section of the lead terminal 14 is square-shaped having four sides of a length a, for example. In FIG. 2, the opening area S1 of the through hole 12, and the cross sectional area S2 of the lead terminal 14 are as follows;
S1=π×)d/2)²
S2=a²

Accordingly, the area ratio R to be shown as the ratio between them is;

$$\begin{matrix}R = S 1 / S 2 \\ = π \times {( d / 2 a )}^{2}\end{matrix}$$

In the experiment, soldering of the lead free solder has been conducted, in case where the cross sectional area S2 of the lead terminal 14 having 0.64 mm as the length a of one side is set to be constant, while the diameter d of the through hole 12 is varied from 1.0 mm to 2.0 mm, and the results have been evaluated. Specifically, the area ratio R has been calculated in case where the diameter d of the through hole 12 is varied to 1.0 mm, 1.2 mm, 1.5 mm, 1.6 mm, 1.8 mm, 1.9 mm, and 2.0 mm. The lead free solder which has been used is a solder of Sn—Ag—Cu, and more specifically, the solder of Sn-3. OAg-0.5Cu.

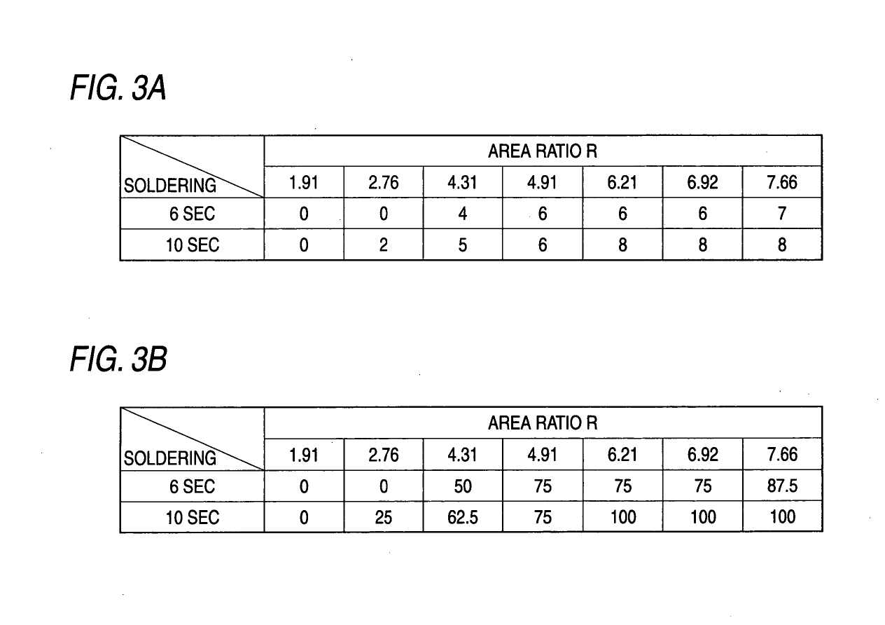

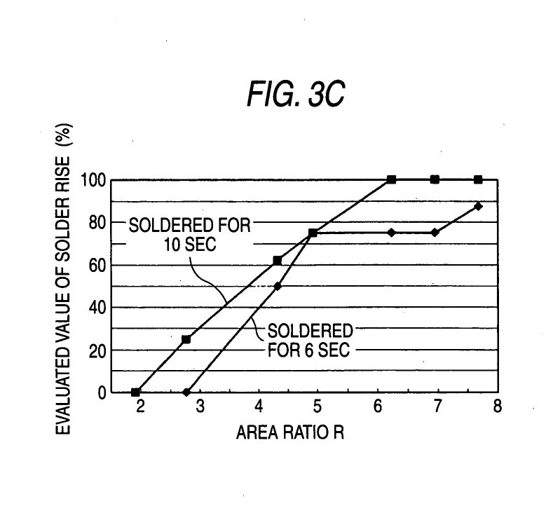

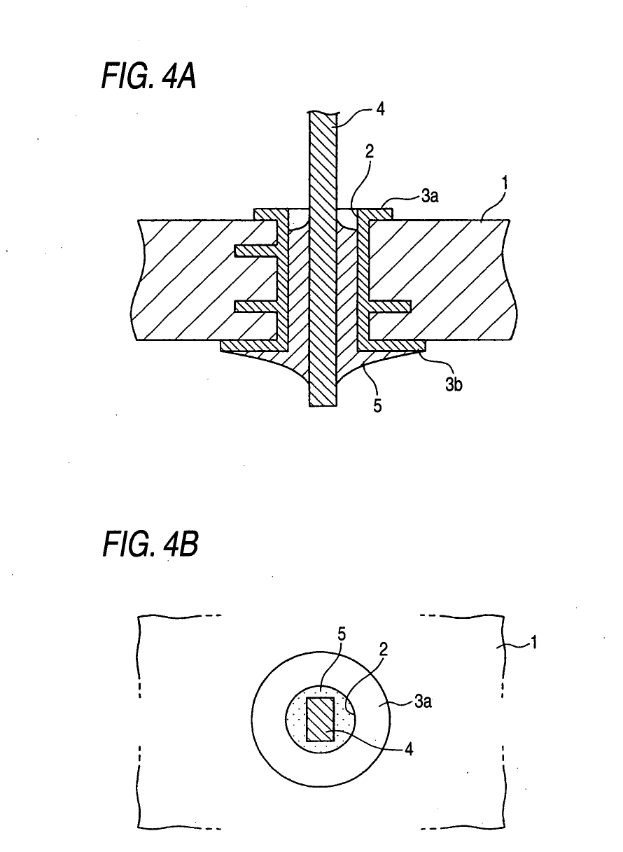

The soldering performance has been evaluated by counting 0 point when the solder rise is 75%, 1 point when the solder rise is more than 75% and less than 100%, and 2 points when the solder rise is 100%. The results are shown in FIG. 3A. Evaluations have been conducted on four pieces respectively, both in case where the soldering time is 6 seconds, and in case where the soldering time is 10 seconds. FIG. 3B shows the points counted as described above, in which a perfect score of 8 points has been converted into 100 points.

FIG. 3C is a graph in which the resulted points with respect to the area ratios R are plotted. It is found from the results that as the area ratio increases from about 4 or more, as an approximate threshold value, the evaluation exceeds 50 points, and the soldering performance has been improved. Moreover, the substantially same results have been obtained in either case of 6 seconds and 10 seconds of the soldering time. Consequently, it is found from this experiment that the soldering performance can be enhanced by setting the area ratio R to be 4 or more.

Although it would be sufficient that the area ratio R is 4 or more, there is a limit in practical application. Specifically, it would be preferable that the area ratio is to such extent that occurrence of a blow hole by soldering may be avoided. Because conditions for occurrence of the blow hole are not determined only by the area ratio R, the area ratio may be preferably determined by experiments.

According to the embodiment as described above, it is possible to obtain a favorable solder rise in case where the lead free solder is soldered, by setting the diameter d of the through hole 12 of the multilayer printed board 11 so that the area ratio R between, the opening area and the cross sectional area of the lead terminal 14 may be 4 or more. As the results, improvement of the soldering performance can be achieved.

Actually, it was possible to obtain the following practical effects, by employing the above described conditions.

(1) In case of a board A, the area ratio R was changed from 2.09 to 4.91 (the diameter d of the through hole was changed from 1.3 mm to 2.0 mm, and sizes of an outer shape of the lead terminal were set to be 1.0 mm×0.64 mm). In this manner, it was possible to obtain a favorable solder rise.

(2) In case of a board B, the area ratio R was changed from 3.7 to 6.0 (the diameter d of the through hole was changed from 1.1 mm to 1.4 mm, and the sizes of the outer shape of the lead terminal were set to be 0.64 mm×0.40 mm). In this manner, it was possible to remarkably enhance the solder rise.

(3) In case of a board C, the area ratio R was changed from 2.09 to 4.91 (the diameter d of the through hole was changed from 1.3 mm to 2.0 mm, and the sizes of the outer shape of the lead terminal were set to be 1.0 mm×0.64 mm). In this manner, it was possible to remarkably enhance the solder rise.

The invention is not limited to the above described embodiment, but can be modified or extended in the following manner.

In the above described embodiment, the experiment has been described with respect to the case in which the cross section of the lead terminal 14 has a square shape. However, the cross section of the lead terminal 14 may have a rectangular shape or a round shape, besides the square shape, in applying this invention.

Moreover, although the lead free solder used in the above described embodiment was the solder of Sn—Ag—Cu, the lead free solder of Sn—Ag can be also used.

What is claimed is:

1. A soldering structure comprising:
a printed board;
a through hole formed in the printed board; and
an electronic component having a lead terminal soldered to the through hole by lead free solder,
wherein an opening area of the through hole is four times or more as large as a cross sectional area of the lead terminal.

2. The soldering structure according to claim 1, wherein the lead free solder is lead free solder of Sn—Ag or Sn—Ag—Cu having a high melting point.
